(19) United States
(12) Patent Application Publication
(10) Pub. No.: US 2022/0105867 A1
(43) Pub. Date: Apr. 7, 2022

(54) IN-TRAILER MONITORING SYSTEM AND RELATED METHODS

(71) Applicant: Continental Automotive Systems, Inc., Auburn Hills, MI (US)

(72) Inventors: Aranza Hinojosa Castro, Ferndale, MI (US); Ibro Muharemovic, Warren, MI (US)

(73) Assignee: Continental Automotive Systems, Inc., Auburn Hills, MI (US)

(21) Appl. No.: 17/064,957

(22) Filed: Oct. 7, 2020

(51) Int. Cl. B60R 1/00; B60P 3/04; B60Q 9/00; A01K 1/00; A01K 29/00; A01K 1/06; H04N 5/225

(52) U.S. Cl. CPC B60R 1/00; B60P 3/04; B60Q 9/00; A01K 1/0094; A01K 29/005; B60R 2300/80; A01K 1/0035; H04N 5/2253; B60R 2300/105; B60R 2300/20; A01K 1/06

(57) ABSTRACT

An in-trailer monitoring system includes one or more surround view cameras mounted within a trailer having a cargo area, a visualization display disposed within a vehicle, and an electronic control unit (ECU) in communication with the visualization display and the one or more surround view cameras, the ECU configured to periodically display: an image from the one or more surround view cameras, and data to the display for a predetermined amount of time.

### TECHNICAL FIELD

The disclosure herein relates to an in-trailer monitoring system.

### TECHNICAL BACKGROUND

When any kind of cargo is being transported in a cargo holding area of a vehicle, for example in a trailer being towed by the vehicle, it is possible that the cargo may move around unexpectedly and/or undesirably or be subjected to unexpected and undesirable changes such as excessive temperature. In addition, for cargo such as animals, the driver is unaware of unmet needs of the animal.

If the animal becomes stressed and moves around within the trailer, it may be difficult for the driver to maintain control of the vehicle. It is also desirable to be able to sense any distress of the animal being transported for the general well-being of the animal.

A problem exists for the vehicle driver in that he may not be aware of issues pertaining to in the cargo holding area leading to a problem with the cargo and/or the cargo holding area. Therefore, there is a need to monitor the cargo holding area of the vehicle.

Existing monitoring systems are known wherein a camera is provided in the cargo holding area. Live video feed information from the camera is displayed to the vehicle driver by means of a screen provided in the vehicle cabin. The driver monitors visually the status of the cargo holding area via the screen. Whilst this is useful, the driver is only alerted to movement in the cargo holding area if the visual impact of the movement is significant enough to be noticed from the screen by the driver who is otherwise concentrating to a greater extent on driving the vehicle safely. Therefore, the driver may fail to notice when there is a problem with the cargo and/or the cargo holding area. Furthermore, such systems may distract the driver of the vehicle from the primary task of driving safely. In some countries such a system is even contrary to road-use regulations. Increasingly in vehicles a driver is presented constantly with a visual display in the form of a satellite navigation system, and so the presence of two visual display screens, one to monitor the cargo and one to monitor navigational status, is particularly distracting.

### BRIEF SUMMARY

An in-trailer monitoring system includes one or more surround view cameras mounted within a trailer having a cargo area, a visualization display disposed within a vehicle, and an electronic control unit (ECU) in communication with the visualization display and the one or more surround view cameras, the ECU configured to periodically display: an image from the one or more surround view cameras, and data to the display for a predetermined amount of time.

In one or more embodiments, the cameras are configured to capture one or more animals within the cargo area, wherein the one or more animals are equine.

In one or more embodiments, the system further includes a sensor coupled with the one or more animals.

In one or more embodiments, the sensor is within a halter configured to be coupled with a horse.

In one or more embodiments, the data includes one or more of animal presence, animal activity, or animal posture.

In one or more embodiments, the data includes one or more of trailer temperature.

In one or more embodiments, the data includes one or more reminders for food, water, or rest for the animal.

A method for in-trailer monitoring including periodically displaying an image from one or more surround view cameras mounted within a trailer having a cargo area on a visualization display disposed within a vehicle, wherein periodically displaying the image is done for a predetermined amount of time. The method further includes periodically displaying data to the visualization display, where an electronic control unit (ECU) is in communication with the visualization display and the one or more surround view cameras.

In one or more embodiments, periodically displaying data to the visualization display is done for the predetermined amount of time.

In one or more embodiments, the data includes animal presence.

In one or more embodiments, the data includes animal activity.

In one or more embodiments, the data includes animal posture.

In one or more embodiments, the data includes one or more of trailer temperature.

In one or more embodiments, the data includes reminders for food for an animal.

In one or more embodiments, the data includes reminders for water for an animal.

In one or more embodiments, the data includes reminders for rest for an animal.

In one or more embodiments, the method further includes sending an alert to the visualization display if the temperature is above or below a predetermined trailer temperature.

### BRIEF DESCRIPTION OF THE DRAWINGS

FIG. 1 illustrates a block diagram of the system, as constructed in accordance with one or more embodiments.

FIG. 2 illustrates a vehicle and trailer layout, as constructed in accordance with one or more embodiments.

FIG. 3 illustrates a vehicle and trailer layout, as constructed in accordance with one or more embodiments.

FIG. 4 illustrates a vehicle and trailer layout, as constructed in accordance with one or more embodiments.

FIG. 5A illustrates a visualization display of the system, as constructed in accordance with one or more embodiments.

FIG. 5B illustrates a set of data that can be provided on the visualization display, in accordance with one or more embodiments.

FIG. 6 illustrates a visualization of the system, as constructed in accordance with one or more embodiments.

FIG. 7 illustrates a visualization of the system, as constructed in accordance with one or more embodiments.

FIG. 8 illustrates a horse halter for use with the system, as constructed in accordance with one or more embodiments.

FIG. 9 illustrates top view of a vehicle and trailer layout with trailer dynamics, as constructed in accordance with one or more embodiments.

FIG. 10 illustrates top view of a vehicle and trailer layout with trailer dynamics, as constructed in accordance with one or more embodiments.

These and other embodiments, aspects, advantages, and features of the present invention will be set forth in part in the description which follows and will become apparent to those skilled in the art by reference to the following description of the invention and referenced drawings or by practice of the invention. The aspects, advantages, and features of the invention are realized and attained by means of the instrumentalities, procedures, and combinations particularly pointed out in the appended claims and their equivalents.

### DETAILED DESCRIPTION

The following detailed description includes references to the accompanying drawings, which form a part of the detailed description. The drawings show, by way of illustration, specific embodiments in which the apparatus may be practiced. These embodiments, which are also referred to herein as “examples” or “options,” are described in enough detail to enable those skilled in the art to practice the present embodiments. The embodiments may be combined, other embodiments may be utilized, or structural or logical changes may be made without departing from the scope of the invention. The following detailed description is, therefore, not to be taken in a limiting sense and the scope of the invention is defined by the appended claims and their legal equivalents.

An in-trailer monitoring system includes one or more surround view cameras mounted within a trailer having a cargo area, a visualization display disposed within a vehicle, and an electronic control unit (ECU) in communication with the visualization display and the one or more surround view cameras, the ECU configured to periodically display: an image from the one or more surround view cameras, and data to the display for a predetermined amount of time.

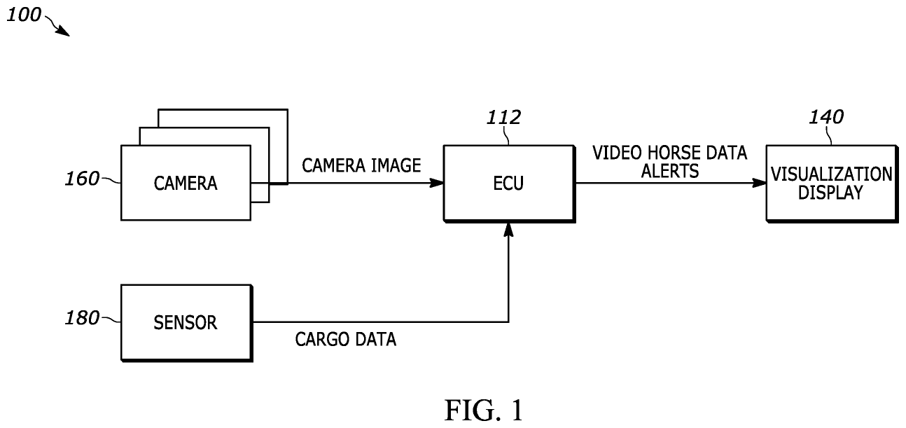

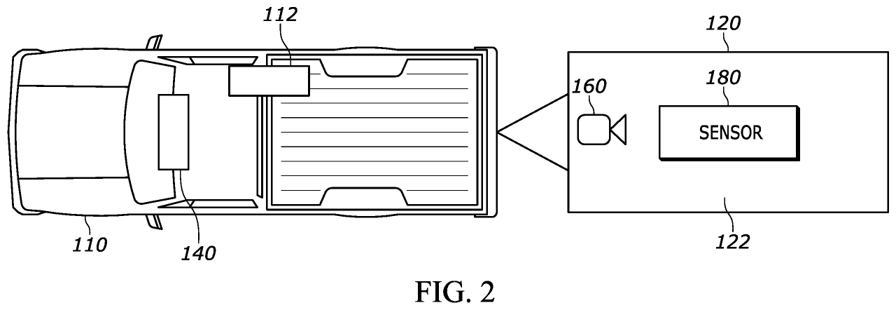

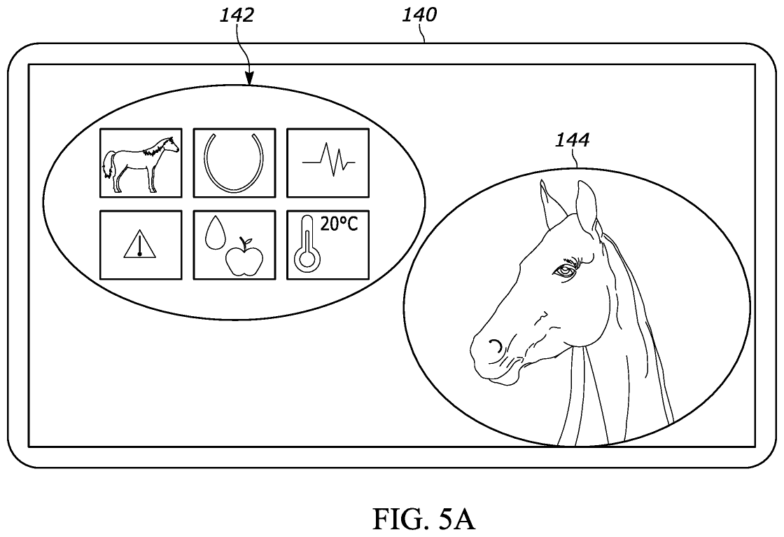

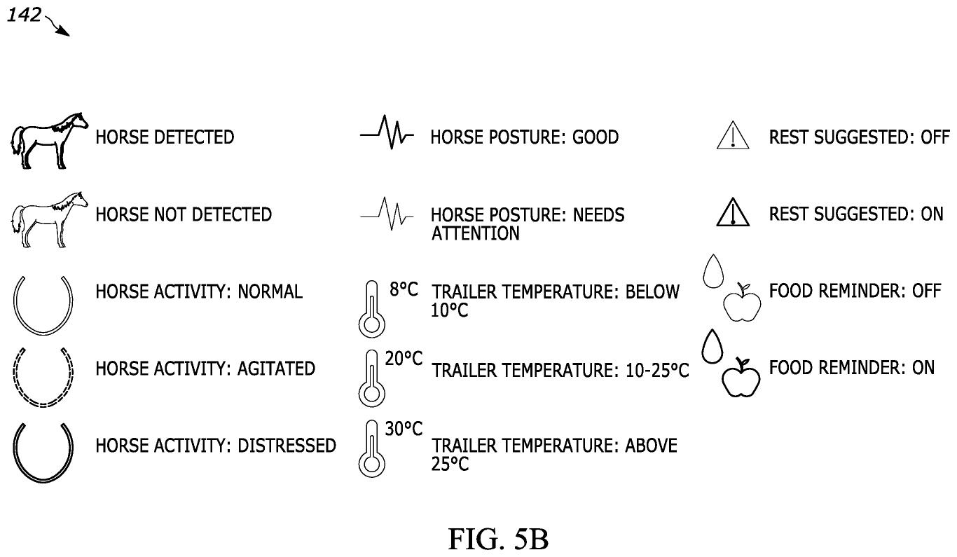

FIG. 1 illustrates the system architecture, which includes one or more surround view cameras 160, an electronic control unit (ECU) 112, at least one visualization display 140, and an optional sensor 180. The display 140 can be the display within the dashboard of a vehicle, or can be a smart phone, tablet, or other device. The one or more cameras 160 is in communication with the ECU 112, and the one or more cameras 160 provides the camera image 144 to the ECU 112 (See FIG. 5A). The one or more cameras 160 are disposed in the trailer 120 (FIG. 2-4). The sensor 180 is in communication with the ECU 112, and the sensor 180 provides cargo data 142 to the ECU 112.

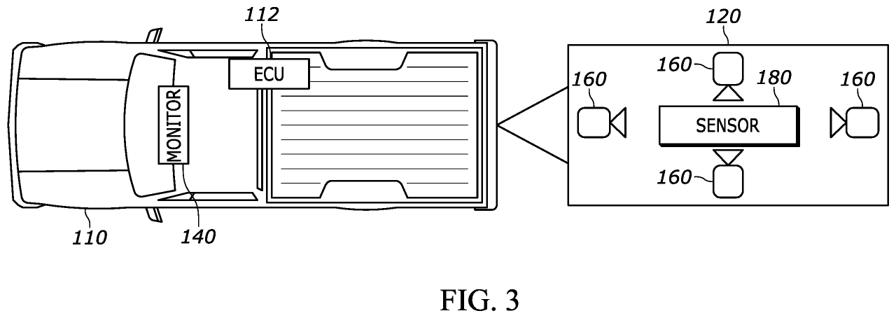

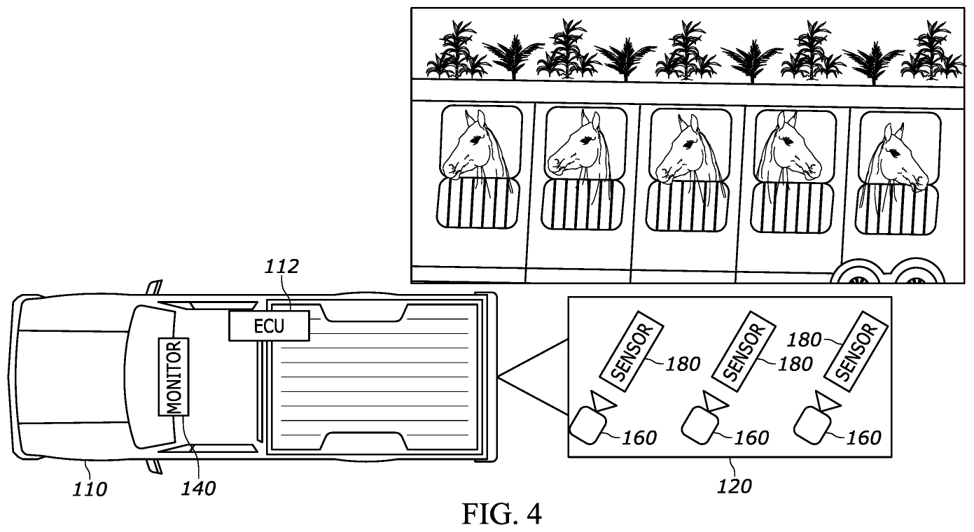

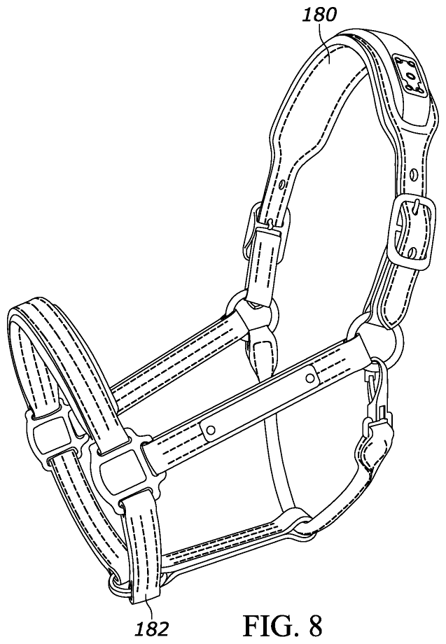

The one or more cameras 160 are configured to capture one or more animals within the cargo area 122 of the trailer 120, as shown in FIG. 2. In one or more embodiments, multiple cameras 160 are disposed within the trailer 120 as shown in FIGS. 3-4. For instance, four cameras 160 can be disposed within the trailer 120, and in a further option at least one sensor 180 is provided. Having four cameras 160 disposed along each side of the trailer 120 will provide a surround-view of the cargo, or animal. FIG. 4 illustrates another option of a camera in each stall for example, for each animal. An optional sensor 180 can be coupled with the animal. In one or more embodiments, the sensor 180 is within a halter 182 which can be mounted on the horse (See FIG. 8).

Referring to FIGS. 5A and 5B, the data 142 is provided on the visualization device 140, along with the image 144 of the cargo. FIG. 5B illustrates the type of data which can be provided on the visualization device 140 which includes, but is not limited to: horse detected, horse not detected, horse activity—normal, nnorse activity—agitated, horse activity—distressed, horse posture—good, horse posture—needs attention, trailer temperature—below 10 degrees C., trailer temperature—10-25 degrees C., trailer temperature—above 25 degrees C., whether a rest is suggested, and a food reminder.

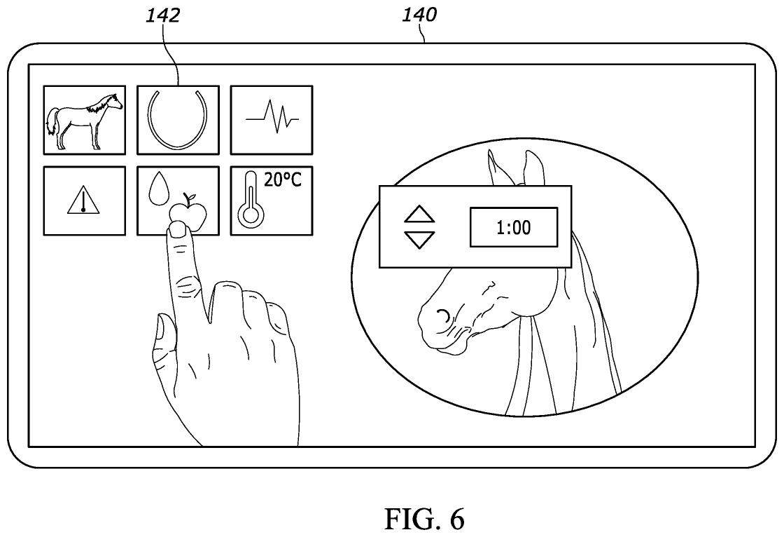

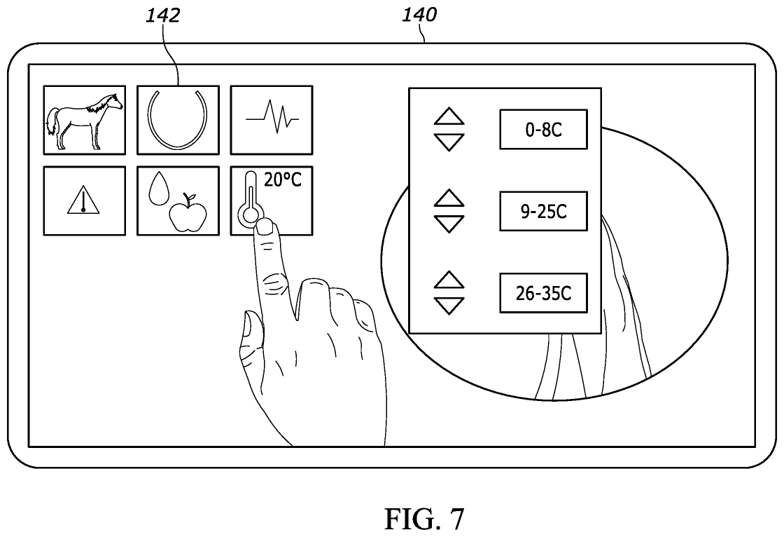

FIGS. 6 and 7 illustrate how a driver can turn on or off the alerts, for example by touching the horse icon. IN one or more embodiment, the video will remain ON until the drivers turns it OFF by toggling the horse presence icon. For assert settings, the driver can program the desired alert, how often the alert is displayed, and the desired ranges, for example, for temperature within the trailer.

In one or more embodiments, the system displays the video from the camera inside the trailer to the display periodically for a predetermined amount of time. In one or more embodiments, the system displays the image from the camera every 30 minutes for minutes. In one or more embodiments, data is also shown in the visualization display, such as, but not limited to horse presence, horse activity, horse posture, trailer temperature and alerts, water and hay reminder, or rest alert.

In one or more embodiments, the system automatically detects if a horse is present inside the vehicle and provides activity and posture status to alert the driver of potential harm or distress the horse could be experiencing. After an animal such as a horse is detected in the trailer, the system alerts the driver then the trailer temperature is too low or too high and require the attention of the driver. The system also provides water and hay reminders in a period established by the driver. In one or more embodiments, the system can detect a long trip and provide rest reminders for the driver to pull over and let the horse out of the trailer. The reminders and timing of such can be programmed by the owner. The system provides relevant data from the inside of the trailer transportation an animal to the driver without requiring the driver to execute secondary tasks while driving.

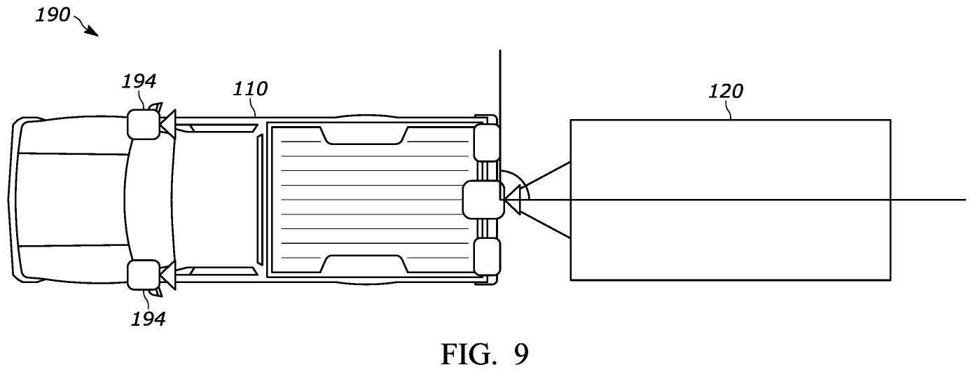

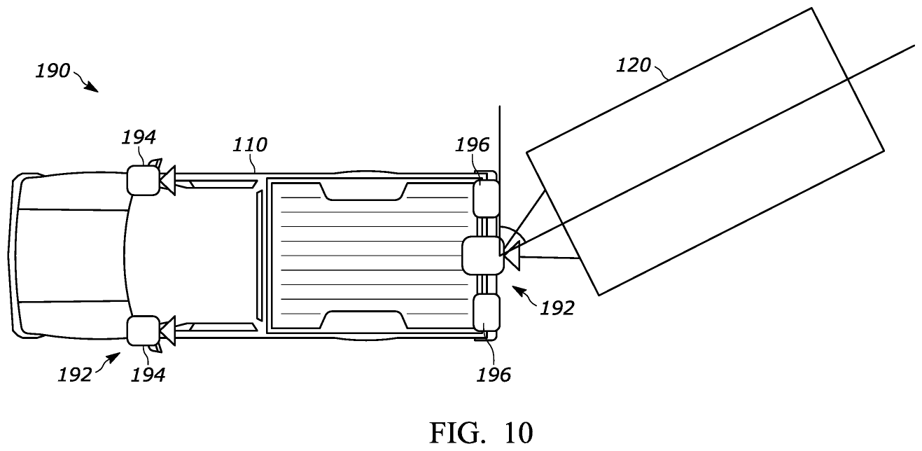

FIGS. 9-10 illustrate an additional embodiment which further includes a trailer dynamics system 190, which determines trailer 120 presence and trailer angle 198, and uses this information to activate the monitoring system 100 as a way of predicting a maneuver that can impact the goods or animals in the trailer. For instance, the systems 100 and 190 include dynamics sensors 192 which includes at least one camera 194 and/or at least one radar 196 used to calculate angle 198, and/or to predict maneuvers of the trailer 120 which would affect the cargo. The sensors 192 can further be used to classify a driving scenario as likely to affect the cargo, and use this information to decide to display the images of the cargo to the driver.

For instance, the system 190 includes sensors 192 that detect the vehicle motion, i.e. speed, angular speed, position etc. The other sensors 192 include, but are not limited to, an inertial measurement unit (IMU) configured to measure the vehicle's linear acceleration (for example using one or more accelerometers) and rotational rate (for example using one or more gyroscopes). In one or more embodiments, the IMU also determines a heading reference of the trailer 120. In one or more embodiments, the sensors 192 such as the IMU can determine the pitch, roll and yaw of the trailer 120.

The system informs the driver of the cargo status while on a road trip, reducing the stops to check on the cargo. The information is provided at intervals set by the driver, and for only a predetermined amount of time. The driver will not be executing secondary tasks while driving due to the cargo monitoring, reducing the distractions that could lead to an accident.

The system allows the driver to monitor animal behavior, such as a horse, during the trip and provides a programmable set of alerts that can serve different animal care needs, for example, providing medicine to the animal. The one or more cameras can include for example a multi-camera system (i.e. four cameras) to provide a 360 degree view of a single animal.

The above description is intended to be illustrative, and not restrictive. Many other embodiments will be apparent to those of skill in the art upon reading and understanding the above description. Embodiments discussed in different portions of the description or referred to in different drawings can be combined to form additional embodiments of the present application. The scope should, therefore, be determined with reference to the appended claims, along with the full scope of equivalents to which such claims are entitled.

1. An in-trailer monitoring system comprising:
one or more surround view cameras mounted within a trailer having a cargo area;
a visualization display disposed within a vehicle; and
an electronic control unit (ECU) in communication with the visualization display and the one or more surround view cameras, the ECU configured to periodically display: an image from the one or more surround view cameras and data to the display for a predetermined amount of time.

2. The in-trailer monitoring system as recited in claim 1, wherein the cameras are configured to capture one or more animals within the cargo area.

3. The in-trailer monitoring system as recited in claim 2, wherein the one or more animals are equine.

4. The in-trailer monitoring system as recited in claim 2, further comprising a sensor coupled with the one or more animals.

5. The in-trailer monitoring system as recited in claim 4, wherein the sensor is within a halter configured to be coupled with a horse.

6. The in-trailer monitoring system as recited in claim 1, wherein the data includes one or more of animal presence, animal activity, or animal posture.

7. The in-trailer monitoring system as recited in claim 1, wherein the data includes one or more of trailer temperature.

8. The in-trailer monitoring system as recited in claim 2, wherein the data includes one or more reminders for food, water, or rest for the animal.

9. The in-trailer monitoring system as recited in claim 1, further comprising a trailer dynamics system including one or more dynamics sensors.

10. A method for in-trailer monitoring, the method comprising:
periodically displaying an image from one or more surround view cameras mounted within a trailer having a cargo area on a visualization display disposed within a vehicle, wherein periodically displaying the image is done for a predetermined amount of time;
periodically displaying data to the visualization display; and
where an electronic control unit (ECU) is in communication with the visualization display and the one or more surround view cameras.

11. The method as recited in claim 10, wherein periodically displaying data to the visualization display is done for the predetermined amount of time.

12. The method as recited in claim 10, wherein the data includes animal presence.

13. The method as recited in claim 10, wherein the data includes animal activity.

14. The method as recited in claim 10, wherein the data includes animal posture.

15. The method as recited in claim 10, wherein the data includes one or more of trailer temperature.

16. The method as recited in claim 9, wherein the data includes reminders for food or water for an animal.

17. The method as recited in claim 9, wherein the data includes reminders for rest for an animal.

18. The method as recited in claim 9, further comprising sending an alert to the visualization display if the temperature is above or below a predetermined trailer temperature.

19. The method as recited in claim 10, further comprising using information from a trailer dynamics system to predict impact to cargo within the trailer.

20. The method as recited in claim 19, further comprising using the information from the trailer dynamics system to decide whether to display the image from the one or more surround view cameras mounted within the trailer on the visualization display
